(19) United States
(12) Patent Application Publication
(10) Pub. No.: US 2007/0223184 A1
(43) Pub. Date: Sep. 27, 2007

(54) Portable electronic monitor stand

(76) Inventor: Roderick D. Garrett, Oakland, CA (US)

Correspondence Address: ROD GARRETT, 2112 WEST ST, OAKLAND, CA, 94612, US

(21) Appl. No.: 11/389,591

(22) Filed: Mar. 27, 2006

(51) Int. Cl. G06F 1/16

(52) U.S. Cl. 361/681

(57) ABSTRACT

A device and method for protecting a flat panel display, which easily converts into a stable stand for the display, and which may be adjustable in height. The base and stand may contain a controller such as a keyboard, a pointing device or game pad, or some combination of these. The components may also contain a computer or other electronic components.

### BACKGROUND

1. Field of Invention

This invention relates to a stand and base which quickly and easily convert into a protective cover for the screen of an electronic display monitor.

2. Description of Prior Art

In the past, many portable devices with electronic displays were produced with no protection for the screen. As a cover was especially needed during transport, screens were often damaged. With portable game machines, handheld personal digital assistants, and multi-media devices such as portable video players, it was most often left entirely to the consumer to find some way to protect the fragile monitor screen of those devices, even though such devices were supposedly designed for portability.

Such portable devices also generally lacked the convenience of any provision for angling the unit up from a flat surface so it could be seen from a normal position. The user was required either to look down on the screen, manually hold it or else find some way to prop it up. This was tiring and inconvenient, however other issues further compounded these disadvantages.

In the case of portable computers, most were of a simple clamshell design, in which the screen element folded down over the computer base for transport. While this did afford protection for the screen, the solution required the base to be as large as the screen. As a result, the computer required more surface space for use than would have been otherwise necessary. Not only did this configuration take up much valuable desk space at home or office, but also made these portable computers extremely awkward in limited quarters such as airline seating.

Another significant problem, common to all these devices, was a need to elevate the screen to a more comfortable viewing height. This was generally not very feasible, and the lack of height adjustment contributed to poor visual acuity, and to physical discomfort in their use.

### OBJECTS AND ADVANTAGES

Accordingly, several objects and advantages of this invention are:

To provide an attached, or attachable, and height adjustable stand which elevates and stabilizes a display a monitor, and which easily converts into an attached protective cover for the monitor screen.

That this attached cover creates a secure and compact package for transport, and that the cover is then easily converted back to a stand. That this is accomplished without any disassembly, or any small or loose parts which might be mislaid.

That this stand may also conveniently house controls such as keyboards, pointing devices or other controllers, so that they are built in, and cannot be mislaid or take up extra space.

That this configuration of stand and monitor might be combined with a computer or other electronics housed in the stand, base, or monitor, or any combination, producing a compact, convenient and safe device for portable use.

That this invention might also be applied to many small electronics, such as multi-media, tablet, communication, or game playing devices, providing similar benefits.

Further objects and advantages are numerous, and will become apparent from consideration of the content of this application.

Specifications

The preferred embodiment of this device is comprised of three primary elements, an electronic display assembly, a central supporting stand, and a base which houses a means of control. These primary elements are joined in tandem by two hinging points, these have friction locking characteristics to maintain the desired relative angles of the articulating elements. The stand serves to adjust the height and angle of the display assembly when in the open angled, elevated position. The base and the stand may also be unfolded to the same plane. In this state, they have approximately the same width and length as the display, and thus they may be rotated to cover and protect the face of display.

The base incorporates a means of control such as a keyboard, game pad, pointing device, or any combination. Electronic instruction may be communicated to and from the display and base through the supporting stand element. The display could house the primary electronics of a computer, game board, or media player, or it could be attached by wires or wirelessly to such primary electronics.

In another embodiment of the invention, the stand and base comprise a housing for the primary electronics and controls of a computer, game playing device, media player, or other accessories. This has several advantages over the prior art in portable computers, in that it provides a substantial height adjustment, as well as a much smaller and more desirable footprint. This will be of great advantage in air travel, on a desk, and in most other circumstances.

In yet another embodiment of the invention, there is provision for the stand and protective cover assembly for easy attachment to a display device such as a tablet computer, gaming or multimedia device using a clip or other means of attachment. This would comprise several very desirable benefits to the user in both stabilizing and adjustably raising the device for viewing, as well as protecting the display for storage or transport. This compact and lightweight invention could be fitted as an accessory to many existing, as well as future devices.

While this invention may seem deceptively simple, the solution required much study and refinement, and represents a unique and radical departure from past means. This argues, along with the fact that no one has yet published or produced the idea—despite a present and growing need for such a product—that it cannot be obvious in conception.

### DESCRIPTION OF DRAWINGS

FIG. 1 shows the device diagonally in the opened position

FIG. 2 shows the device in profile in the closed position

FIG. 3 shows another iteration of the invention in profile, wherein the stand element and base comprise a housing for the primary electronics and controls of a portable computer, media playback, communication, or gaming device.

FIG. 4 shows the embodiment above wherein the stand and the base only serve alternately as a stand or a cover for the display, and shows a means of attachment to the display

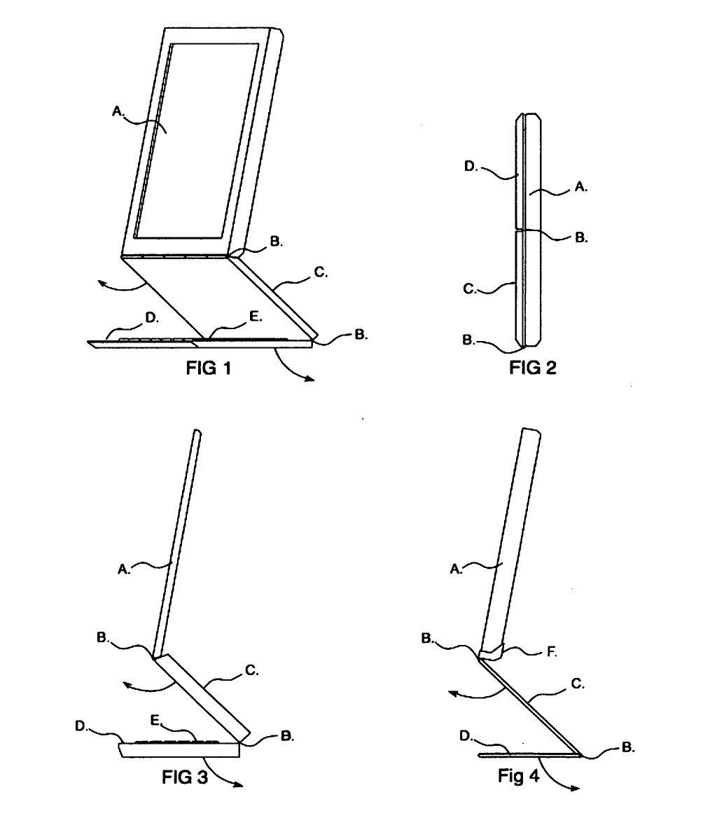

### LIST OF REFERENCE NUMERALS

A. Display
B. Hinge
C. Stand
D. Base
E. Control
F. Attachment

I claim:

1. A portable electronic monitor stand comprising:
A. a means of hinging a display to a device which is comprised of two primary elements, said elements comprised of a stand and a base with a means of hinging said stand to said base, said devise capable of being angled to support said display or to be unfolded and rotated to cover the face of said display
B. the invention of claim 1 wherein said device incorporates a means of control for the electronic display or other electronic components
C. the invention of claim 1 wherein said device or said display incorporates a computer, or media or game playing device
D. the invention of claim 1 wherein said device or said display incorporates other accessories
E. the invention claim 1 wherein said device incorporates a means for easy attachment to said display.
